(19) United States
(12) Patent Application Publication
(10) Pub. No.: US 2016/0154554 A1
(43) Pub. Date: Jun. 2, 2016

(54) VISUAL INDICATION METHOD AND DEVICE

(71) Applicant: Alibaba Group Holding Limited, Grand Cayman (KY)

(72) Inventor: Xinyue Fang, San Diego, CA (US)

(21) Appl. No.: 14/951,239

(22) Filed: Nov. 24, 2015

(30) Foreign Application Priority Data
Nov. 28, 2014 (CN) 201410710348.X

(51) Int. Cl. G06F 3/0483; G06F 3/0481

(52) U.S. Cl. CPC G06F 3/0483; G06F 3/0481; G06F 3/04812

(57) ABSTRACT

Methods and devices for providing notifications. Under conventional techniques, users often forget relationship between multiple windows. This results in poor user experience. The implementations include displaying a first association identifier on a tab of the second window after determining the second window associated with the first window, and displaying a first association identifier on a tab of the second window. Accordingly, the user knows the relationship between these windows without reading the content of the windows. This improves user experience.

### CROSS REFERENCE TO RELATED PATENT APPLICATIONS

This application claims priority to Chinese Patent Application No. 201410710348.X, filed on Nov. 28, 2014 entitled “Method and Apparatus of Providing Prompt Message,” which is hereby incorporated by reference in its entirety.

### TECHNICAL FIELD

The present disclosure relates to the field of browser technology, more particularly, to methods and devices for providing visual indications to users.

### BACKGROUND

With the development of computer and Internet technology, users have been able to browse a variety of information on the Internet through browsers. To improve user experience, most browsers generally adopts a multi-window mode, which uses tabs to identify window.

FIG. 1 is a schematic diagram of an illustrative browser running on the multi-window mode. As illustrated in FIG. 1, a browser creates three windows. For example, a user uses the browser to open three links each corresponding to a page displayed in a window. The browser sets a corresponding tab on each window to identify the window. As illustrated in FIG. 1, the browser currently displays the window corresponding to the first tab. When the user wants to browse the page corresponding to the second tab, the user may click the second tab such that the browser displays the corresponding window.

As illustrated in FIG. 1, when the user clicks a certain link, the browser will create a new window and add a new tab for the created window. For example, if the user clicks a certain link in a window A, the browser will create a window B corresponding to the clicked link. The window A is considered as a parent window; the window B is considered as window A's child window. Sometimes, the user may click multiple links in the parent window, and the browser will create multiple corresponding child windows. In these instances, users are often required to switch back and forth between parent windows and child windows. For example, the user may click multiple object links in an object list page in a parent window, and the browser will create multiple child windows to display these object pages.

In these instances, the user has to switch back and forth between the multiple object pages. However, when there are too many child windows, the user may forget the parent-child relationship between these windows. The user may have to check content displayed on all of these windows to find the right page. This leads to poor user experience.

### SUMMARY

Implementations herein relate to methods and devices for providing notifications. Under conventional techniques, users often forget relationship between multiple windows that are created by a browser. This results in poor user experience for Internet browsing. This Summary is not intended to identify all key features or essential features of the claimed subject matter, nor is it intended to be used alone as an aid in determining the scope of the claimed subject matter.

The implementations include a method for providing notifications. The method may include determining, by a computing device, a first window and a second window that is associated with the first window and displaying a first association identifier on a tab of the second window.

The implementations further include a system for providing notifications. The system may include a determining module configured to determine a first window and a second window that is associated with the first window and a display module configured to display a first association identifier on a tab of the second window.

The implementations include methods and systems for providing notifications. The implementations include determining a first window and a second window that is associated with the first window, and displaying a first association identifier on a tab of the second window. Accordingly, users may understand relationships among windows created by the browser without reading the content of the windows. This improves user experience.

### BRIEF DESCRIPTION OF THE DRAWINGS

The Detailed Description is described with reference to the accompanying figures. The use of the same reference numbers in different figures indicates similar or identical items.

FIG. 1 is a schematic diagram of an illustrative browser mode with multiple windows under conventional techniques.

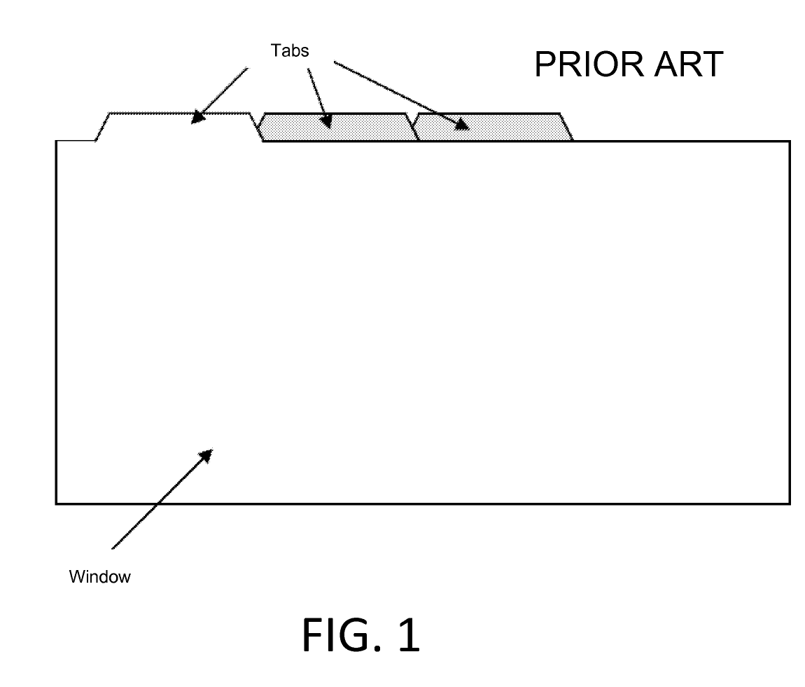

FIG. 2 is flow chart of an illustrative process for providing visual indications.

FIG. 3A is a schematic diagram of an illustrative browser displaying a first window.

FIG. 3B is a schematic diagram of an illustrative browser displaying a second window that has been created.

FIG. 3C is a schematic diagram of an illustrative browser displaying a second window.

FIG. 3D is a schematic diagram of an illustrative browser displaying a link corresponding to a second association identifier.

FIG. 3E is a schematic diagram of an illustrative browser displaying a third association identifier.

FIG. 3F is a schematic diagram of an illustrative browser displaying a fourth association identifier.

FIG. 4 is a schematic diagram of an illustrative computing architecture that enable providing notifications.

### DETAILED DESCRIPTION

For the purposes of this disclosure and for technical solutions and advantages to be clear, the following examples and the accompanying drawings are provided. Obviously, the described examples do not represent all of the implementations of the present disclosure. Based on the implementations in the present disclosure, other implementations made by those of ordinary skill in the art without creative efforts are within the scope of the present disclosure.

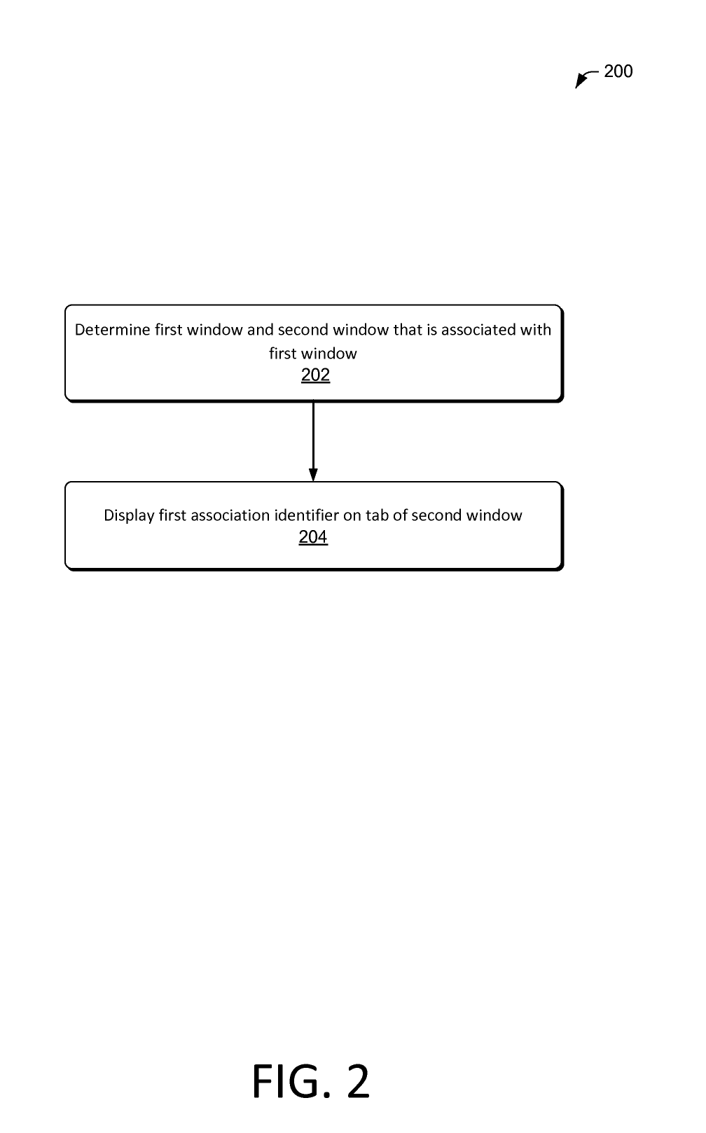

FIG. 2 is flow chart of an illustrative process for providing notifications. At 202, a browser implemented by a computing device may determine a first window and a second window associated with the first window.

In implementations, the browser may monitor a user's operations in a first window and determine the first window and a second window associated with the first window. In these instances, the second window includes a parent window of the first window and/or a child window. Accordingly, a relationship of the implementations herein may include a “parent-child” relationship.

In implementations, a user may click a link and the browser may create a second window displaying content corresponding to the clicked link. For example, the second window is a child window of the first window, that is, the first window is the parent window of the second window.

At 204, the computing device may display a first association identifier on a tab of the second window. In general, a browser displays a single window at one time while tabs of multiple windows are displayed at the same time.

In implementations, the browser may display a first association identifier on a tab of the second window after determining the second window is associated with the first window. In these instances, the first association identifier on the tab of the second window may be displayed using, but not limited to using, preset patterns including static images and dynamic images, default text, and/or preset colors of the tab of the second window.

In implementations, the browser may display a first association identifier on tabs of multiple second windows after determining the multiple second windows associated with the first window. Further, among the multiple second windows, if one second window is a parent window of the first window, all other second windows are child windows of the first window. The first association identifier displayed on the first window and the first association identifiers displayed on the multiple second windows may be the same or not.

In implementations, the browser may set the tab of the first window's parent window as red, and the tabs of the first window's child windows as yellow. Accordingly, using the first association identifiers displayed on the tabs of the first window and the second window, the user may know that the window tabbed by the first association identifier (the second window) and the displayed window (the first window) are related without having to repeatedly check each page displayed in the window. This effectively improves user experience.

At 202, when the browser determines a first window and a second window that is associated with the first window, the browser may monitor a user operation performed on the first window. In response to a determination that the user operation includes a click-through of a link in the first window and that a window corresponding to the link has not been created, the browser may create a window displaying the content corresponding to the link. Further, the browser may designate the created window as the second window that is associated with the first window. For example, the first window is the parent window of the second window, and the second window is a child window of the first window.

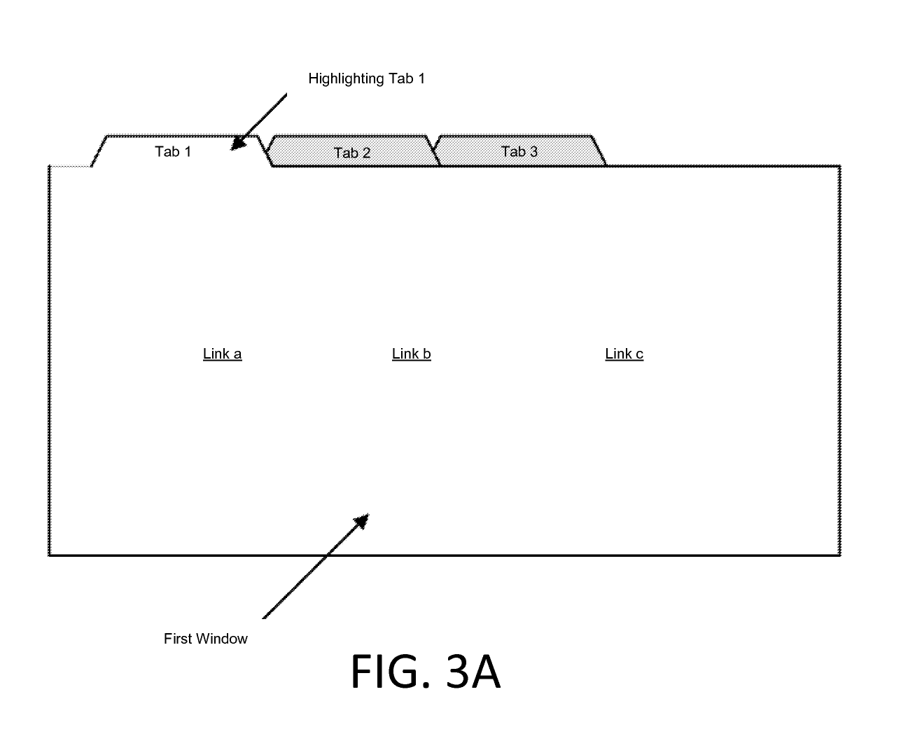

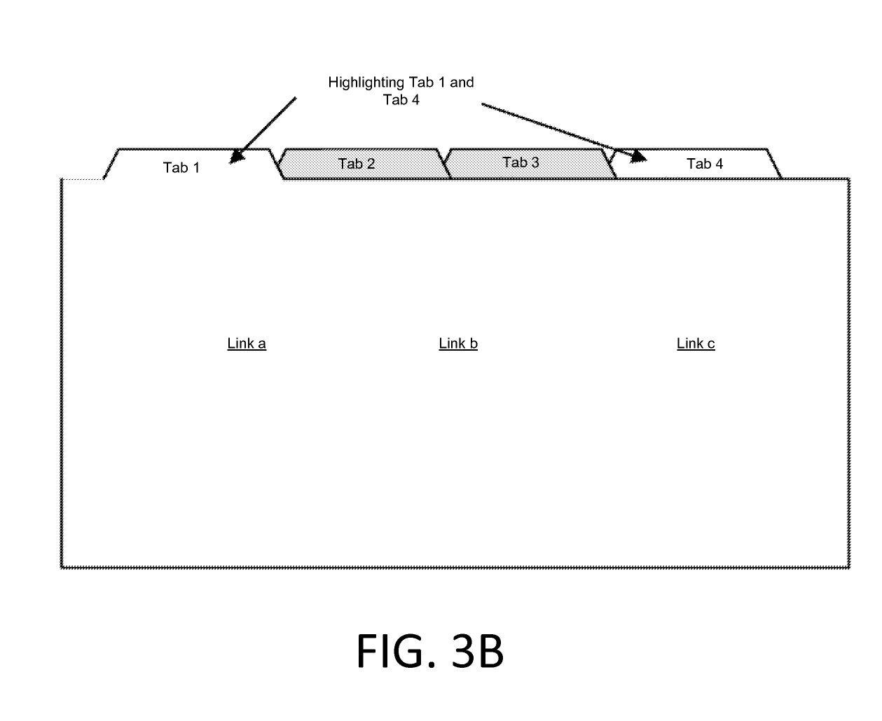

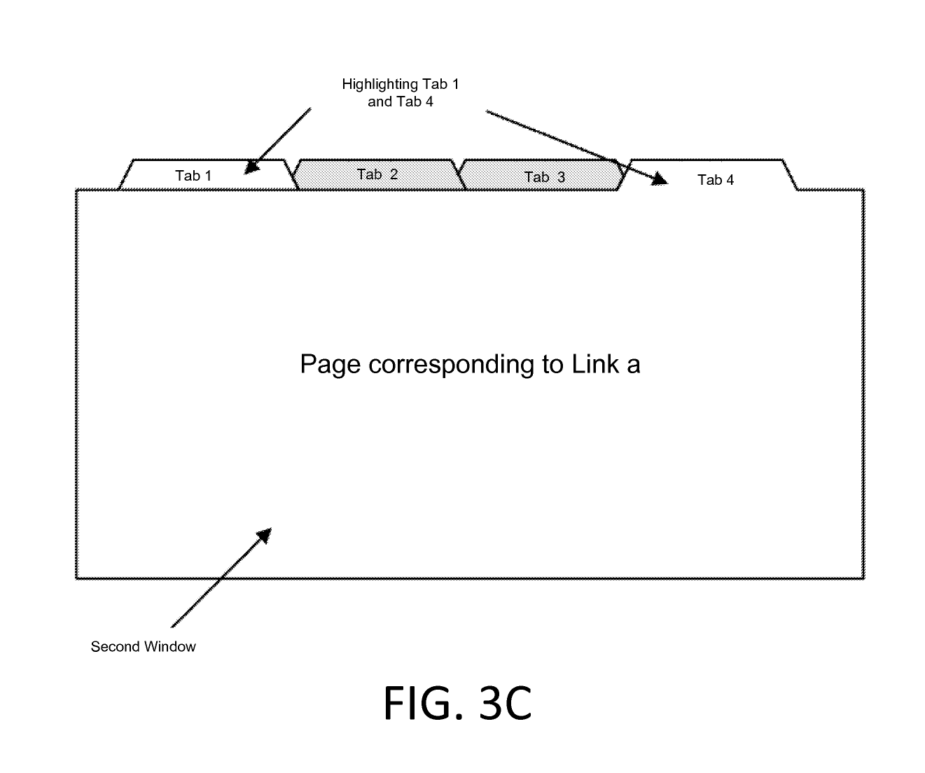

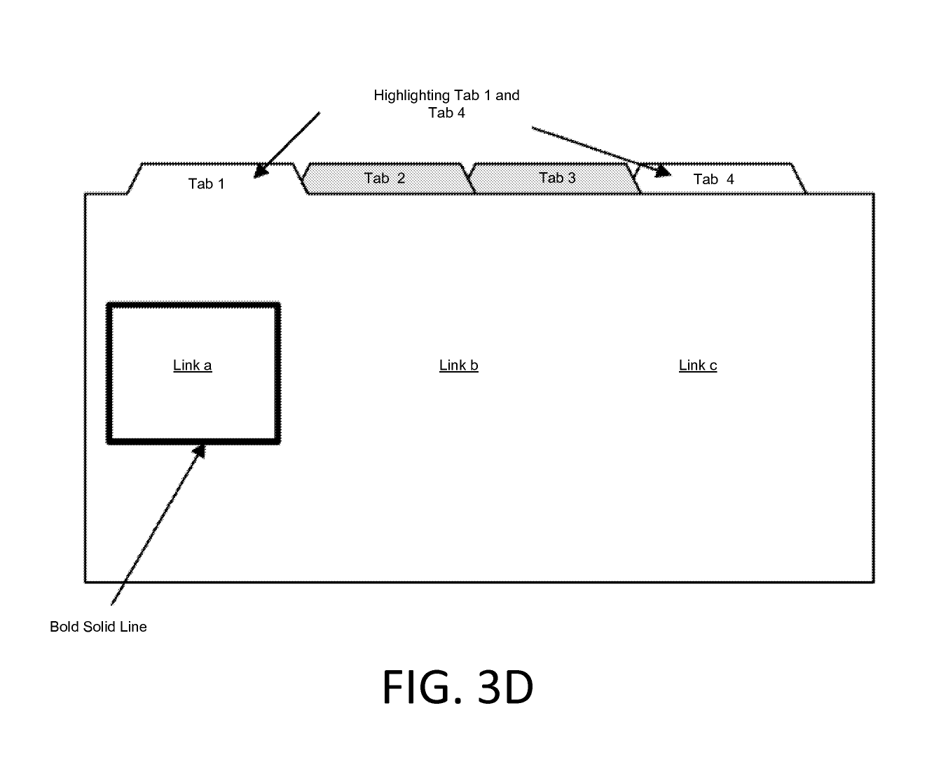

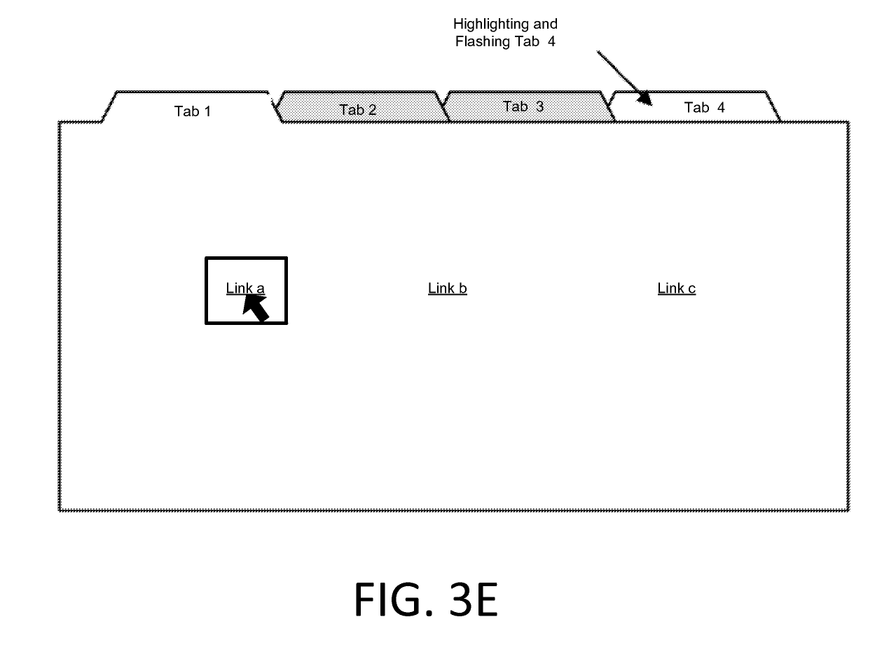

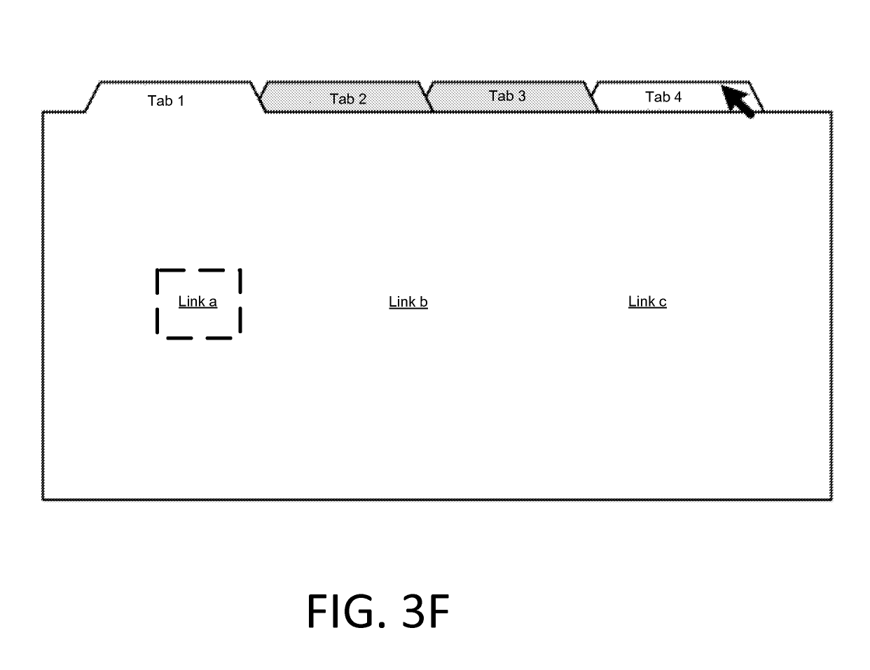

FIG. 3A is a schematic diagram of an illustrative browser displaying a first window. As illustrated in FIG. 3A, the page displayed on the first window includes a link a, a link b, and a link c, and the tab on the first window is a tab 1. In addition to the first window, the browser further creates two windows using a tab 2 and a tab 3. In FIG. 3A, the browser highlights the tab 1 of the first window. If a user clicks the link a, and the browser detects the click-through of the link a, the browser may determine whether a window corresponding to the tab is created based on pages corresponding to links on multiple windows and the link a.

Suppose that the window corresponding to the link a has not been created. The browser may create a new window to display the content corresponding to the link a. As illustrated in FIG. 3B, the browser may designate the created window as the second window.

FIG. 3B is a schematic diagram of an illustrative browser displaying a second window that has been created. As illustrated in FIG. 3B, based on the click-through by the user, the browser may create the second window displaying the content of the link a, and highlight a tab 4 for the second window.

After the browser creates the second window, the browser may not switch the window that is currently displayed to the second window. In other words, the browser may still display the first window.

As illustrated in FIG. 3B, the browser may determine the second window as a child window of the first window and highlight the tab 4 of the second window after creating the second window.

Based on the highlighted tab 1 and tab 4, as illustrated in FIG. 3B, the user may know that the window corresponding to the tab 4 (the second window) and the window that is currently displayed and corresponds to tab 1 are related (the first window).

Further, after determining that the second window is a child window of the first window, the browser may record the relationship between the first and second windows: the first window is the parent window of the second window, and the second window is a child window of the first window. When the user clicks the tab of the second window, the browser may switch the window that is currently displayed to the second window.

Further, based on the recorded relationship, the browser may display the first association identifier on the tab of the parent window of the second window. In implementations, a parent window is determined when the window is created. Further, in response to a determination that the user operation includes a click-through of a link in the first window and that a window corresponding to the link is created, the browser may display the window (the second window). The browser may switch the windows that is currently displayed to the second window.

As illustrated in FIG. 3B, the browser has created the second window displaying the content corresponding to the link a, and highlighted the tab 4 of the second window. It is equivalent to displaying the first association identifier on the tab 4.

When the browser detects that the user clicks the link a again, the browser may create the corresponding content that is displayed on currently created windows. In addition, the browser may determine that the window is created to display the content corresponding to the link a before the user clicks the ink a. In these instances, the browser may directly display the second window, as illustrated in FIG. 3C.

FIG. 3C is a schematic diagram of an illustrative browser displaying a second window. As illustrated in FIG. 3C, the browser may switch the windows that is currently displayed to the second window, and highlight the tab 4 and the tab 1.

It should be noted that, the browser highlights the tab 4 because the window that is currently displayed is the second window corresponding to the tab 4. The browser highlights the tab 1 because the first window corresponding to the tab 1 is the parent of the second window. Therefore, the tab 1 is still highlighted.

In implementations, a single page may include multiple links. Accordingly, a window may display multiple links, and a user may forget which links the user has clicked.

In implementations, the browser may detect that the user clicks a link displayed in the first window and create the second window. Further, the browser may display the second association identifier to the link on the first window to show that the second window displaying the content of corresponding to the link has been created. In these instances, the second association identifier on the tab of the second window may be displayed using but not limited to: preset patterns (including static images and dynamic images), default text, and/or preset colors of the tab of the second window.

In implementations, the browser may detect that the user clicks a link displayed in the first window, and then the browser may create the second window. Further, the browser may determine an area of the first window to display the link and display the second association identifier in the area.

As illustrated in FIG. 3B, the browser may detect that the user clicks the link a displayed in the first window and create the second window. Further, the browser may determine an area of the first window to display the link a and display a boundary line of the area to indicate that the second window displaying the content corresponding to the link a has been created, as illustrated in FIG. 3D.

FIG. 3D is a schematic diagram of an illustrative browser displaying a link corresponding to a second association identifier. As illustrated in FIG. 3D, the browser displays a boundary line shown as a bold solid line surrounding the link a. Accordingly, the user may know that the user has clicked the link a. The browser has stored the window displaying the content corresponding to the link a, and therefore there is no need to check content pages of windows. This improves user experience.

In implementations, the user may click multiple links. In these instances, a parent window may have multiple child windows. A user may forget which child window corresponds to a link in the parent window.

In implementations, the browser may detect that the user clicks a link displayed in the first window, and then the browser may create the second window. The browser may detect whether the user performs a first designated operation on the link. The browser may further detect whether the user performs a second designated operation on the tab of the second window. In response to a determination that a user performs a first designated operation on the link, the browser may display a third association identifier on a tab of the second window.

In these instances, the first designated operation may include hovering a cursor over the link. In response to a determination that a user performs a second designated operation on the tab of the second window, the browser may display a fourth association identifier on a tab of the first window. The second designated operation may include hovering a cursor over the tab of the second window. The cursor includes, but is not limited to, a mouse cursor. The third association identifier on the tab of the second window may be displayed using, but not limited to: preset patterns (including static images and dynamic images), default text, and/or preset colors of the tab of the second window.

The first association identifier and the third association identifier may be different. The fourth association identifier and the second association identifier may be different.

As illustrated in FIG. 3D, the browser may detect that the user clicks the link a displayed in the first window, and then the browser may create the second window. Further, the browser may determine that the second window is a child window of the first window.

The browser may highlight the tab 1 of the first window and the tab of the child window of the first window (the second window). Further, the browser may display a boundary line of the area to indicate that the second window displaying the content corresponding to the link a has been created. When the browser detects that the cursor is hovered over the link a displayed in the first window, as illustrated in FIG. 3E (black arrow in FIG. 3E showing a mouse cursor), the browser will change the tab 4 that is currently highlighted on the second window 4 to flash and be highlighted to indicate the third association identifier for the tab 4. This further indicates that the link hovered by the mouse cursor corresponds to the highlighted and flashing window.

When the browser detects that the cursor is hovered over the tab 4 of the second window, as shown in FIG. 3F (black arrow in FIG. 3F representing the mouse cursor), the browser will change the bold solid line of the boundary line of the link a to bold dash line to indicate the fourth association identifier for the link a.

The browser may indicate that a page displayed in the window corresponding to the tab that the mouse cursor is hovering over is the page that is “surrounded” by the bold dash line and corresponds to the link.

In implementations, when the browser closes the first and/or second window, the browser may delete one or more of the first, second, third, and fourth association identifiers.

The implementations include a system for providing visual indications. The system may be implemented using the method described above.

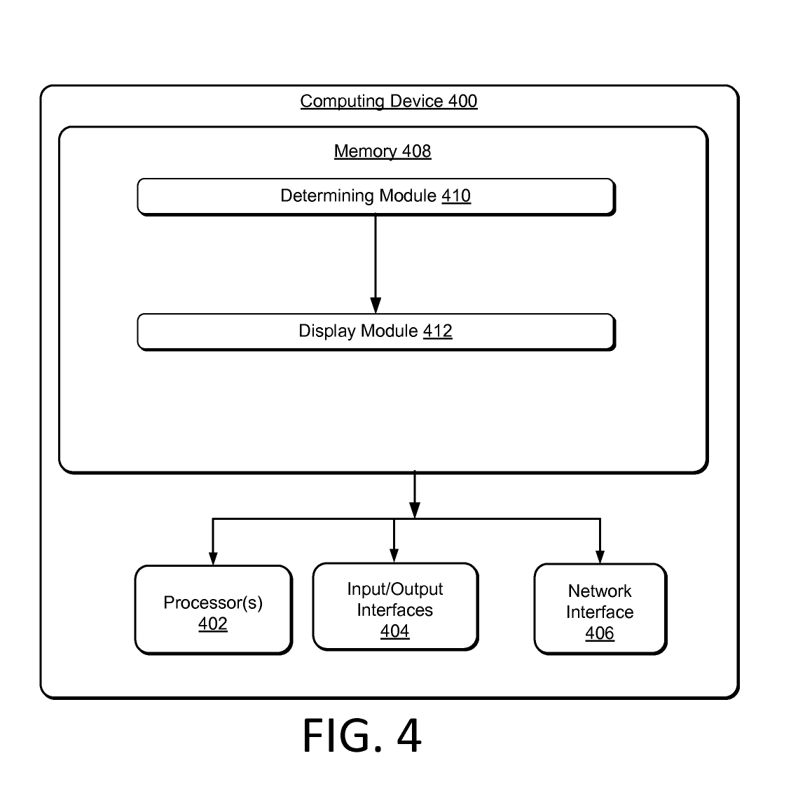

FIG. 4 is a schematic diagram of an illustrative computing architecture that enable providing notifications. The computing device 400 may be a user device or a server for providing notifications. In one exemplary configuration, the computing device 400 may include one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a determining module 410 and a display module 412. The determining module 401 may be configured to determine a first window and a second window that is associated with the first window. The display module 402 may be configured to display a first association identifier on a tab of the second window. The second window includes a parent window of the first window and/or a child window.

In implementations, the determining module 412 may be further configured to monitor a user operation performed on the first window. In response to a determination that the user operation include a click-through of a link in the first window and that a window corresponding to the link is not created, the browser may create a window displaying the content corresponding to the link, and designate the created window as the second window that is associated with the first window. In these instances, the second window is a child window of the first window, and the first window is the parent window of the second window.

The display module 412 may be further configured to display a second association identifier corresponding to the link on the first window in response to a determination that the second window is created by the determining module 410. The second window is created in response to a click-through of a link on the first window; the second window is a child window of the first window and displays a page corresponding to the link.

The display module 412 may be further configured to display a third association identifier on a tab of the second window in response to a determination that a user performs a first designated operation on the link. In these instances, the first designated operation may include hovering a cursor over the link. The second window is created in response to a click-through of a link on the first window. The second window is a child window of the first window and displays a page corresponding to the link.

The display module 412 may be further configured to display a fourth association identifier on a tab of the first window in response to a determination that a user performs a second designated operation on the tab of the second window. In these instances, the second designated operation may include hovering a cursor over the tab of the second window.

The display module 412 may be further configured to display the second window in response to a determination that the user operation includes a click-through of a link in the first window and that a window corresponding to the link has been created.

In implementations, the above-described apparatus shown in FIG. 4 may be located in a client terminal, which implements a browser.

The implementations further relate to an electronic device. The electronic device may include a display, a processor, and memory configured to store the browser to display a window on the display. The window includes a tab display area and a page sharing display area, and the tab display area includes a first tab. In response to a determination that the first tab is in an active state, the browser displays one or more link objects corresponding to the first tab in the page sharing display area.

In these instances, the one or more link objects corresponds to an operation instruction entered by a user and/or a display a second tab in the tab display area. The second tab and the operation instruction are associated with through a visual tab.

The implementations include methods and systems for providing notifications. The browser may display a first association identifier on a tab of the second window after determining the second window associated with the first window. The users may know the relationship between windows without reading the content of the windows. This improves user experience.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method for providing visual indication for a browser, the method comprising:
determining, by one or more processors of a computing device, a first window;
determining, by the one or more processors, a second window that is associated with the first window; and
displaying, by the one or more processors, a first visual indicator tab which is used to visually indicate a linked relationship between the first window and the second window.

2. The method of claim 1, wherein the second window includes a parent window of the first window, a child window of the first window, or a combination thereof.

3. The method of claim 1, wherein the determining the second window that is associated with the first window comprises:
monitoring a user operation performed within the first window;
creating a window corresponding to a link in response to a determination that the user operation includes a click-through of the link in the first window and that the window corresponding to the link is not created; and
designating the created window as the second window that is associated with the first window, wherein the second window is a child window of the first window, and wherein the first window is a parent window of the second window.

4. The method of claim 3, further comprising:
displaying a second visual indicator corresponding to the link on the first window prior to the creating the window corresponding to the link.

5. The method of claim 1, wherein the second window is created in response to a click-through of a link on the first window, wherein the second window is a child window of the first window and displays a page corresponding to the link, and wherein the method further comprises:
displaying a third visual indicator on a tab of the second window in response to a determination that a user performs a first designated operation on the link, the first designated operation including hovering a cursor over the link.

6. The method of claim 1, wherein the second window is created in response to a click-through of a link on the first window, wherein the second window is a child window of the first window and displays a page corresponding to the link, and wherein the method further comprises:
displaying a fourth association identifier on a tab of the first window in response to a determination that a user performs a second designated operation on the tab of the second window, the second designated operation comprising hovering a cursor over the tab of the second window.

7. The method of claim 3, further comprising:
displaying the second window in response to a click-through of the link on the first window and to a determination that the second window corresponding to the link has been created.

8. A device for providing visual indication for a browser, the device comprising:
one or more processors; and
memory to maintain a plurality of components executable by the one or more processors, the plurality of components comprising:
a determining module configured to determine a first window and a second window that is associated with the first window, and
a display module configured to display a first visual indicator which is used to visually indicate a linked relationship between the first window and the second window tab.

9. The device of claim 8, wherein the second window includes a parent window of the first window, a child window of the first window, or a combination thereof.

10. The device of claim 8, wherein the determining module is further configured to:
monitor a user operation performed on the first window;
create a window corresponding to a link in response to a determination that the user operation includes a click-through of the link in the first window and that the window corresponding to the link is not created; and
designate the created window as the second window that is associated with the first window, wherein the second window is a child window of the first window, and wherein the first window is a parent window of the second window.

11. The device of claim 10, wherein the display module is further configured to:
display a second visual indicator corresponding to the link on the first window in response to a determination that the second window is created.

12. The device of claim 8, wherein the second window is created in response to a click-through of a link on the first window, wherein the second window is a child window of the first window and displays a page corresponding to the link, and wherein the display module is further configured to:
display a third visual indicator on a tab of the second window in response to a determination that a user performs a first designated operation on the link, the first designated operation comprising hovering a cursor over the link.

13. The device of claim 8, wherein the second window is created in response to a click-through of a link on the first window, the second window is a child window of the first window and displays a page corresponding to the link, and the display module is further configured to:
display a fourth visual indicator on a tab of the first window in response to a determination that a user performs a second designated operation on the tab of the second window, the second designated operation including hovering a cursor over the tab of the second window.

14. The device of claim 10, wherein the display module is further configured to:
display the second window in response to a click-through of the link on the first window and to a determination that the second window corresponding to the link has been created.

15. A device, comprising:
a display;
one or more processors; and
memory configured to store a browser that is executed by the one or more processors to perform acts comprising:
displaying a window on the display, the window including a tab display area and a page sharing display area, the tab display area including a parent tab and at least one child tab;
displaying one or more link objects corresponding to the parent tab in the page sharing display area in response to a determination that the first tab is in an active state; and
displaying at least one visual indicator which is used to visually indicate a parent-child relationship between the parent tab and the at least one child tab.

16. The device of claim 15, wherein the acts further comprise:
determining an additional window associated with the window, the additional window including an additional display area that includes the at least one child tab; and
displaying a first visual indicator on the at least one child tab.

17. The device of claim 16, wherein the determining the additional window associated with the window comprises:
monitoring a user operation performed within the window;
creating the additional windows corresponding to a link in response to a determination that the user operation includes a click-through of the link in the window and that the additional window corresponding to the link is not created; and
associating the additional window with the window, wherein the additional window is a child window of the window, and wherein the window is a parent window of the additional window.

18. The device of claim 17, wherein the acts further comprise:
displaying a second association identifier corresponding to the link on the window prior to the creating the additional windows corresponding to the link.

19. The device of claim 16, wherein the acts further comprise:
displaying a third association identifier on the second tab of the additional window in response to a determination that a user performs a first designated operation on the link, the first designated operation comprising hovering a cursor over the link.

20. The device of claim 19, wherein the additional window is created in response to a click-through of the link on the window, wherein the additional window is a child window of the window and displays a page corresponding to the link, and wherein the acts further comprise:
displaying a fourth association identifier on a tab of the window in response to a determination that a user performs a second designated operation on the tab of the additional window, the second designated operation comprising hovering a cursor over the second tab.
